(19) United States
(12) Patent Application Publication
(10) Pub. No.: US 2026/0279695 A1
(43) Pub. Date: Sep. 17, 2026

(54) ON-LOAD TAP CHANGER COVER AND ON-LOAD TAP CHANGER DEVICE

(71) Applicant: Maschinenfabrik Reinhausen GmbH, Regensburg (DE)

(72) Inventors: Moritz Bengler, Regensburg (DE); Klaus Schlepp, Maxhütte-Haidhof (DE); Jürgen Niesner, Lappersdorf (DE)

(21) Appl. No.: 19/168,846

(22) PCT Filed: Mar. 6, 2024
(86) PCT No.: PCT/EP2024/055844

§ 371 Date: Sep. 25, 2025

(30) Foreign Application Priority Data
Apr. 5, 2023 (DE) 10 2023 108 700.2

(51) Int. Cl. H01H 9/00

(52) U.S. Cl. CPC H01H 9/0044

(57) ABSTRACT

An on-load tap-changer may have a cover. The cover includes a cover element with a first opening, and a throttle. The throttle is arranged in the first opening. The on-load tap-changer cover can be arranged such that the throttle is between a diverter switch compartment and a pressure relief device of an on-load tap changer such that a throughflow of an insulating medium is throttled by the throttle in the event of a rapid pressure increase in the diverter switch compartment.

### CROSS REFERENCE TO RELATED APPLICATIONS

This application is a U.S. National Phase application under 35 U.S.C. § 371 of International Application No. PCT/EP2024/055844, filed on Mar. 6, 2024, and claims benefit to German Patent Application No. DE 10 2023 108 700.2, filed on Apr. 5, 2023. The International Application was published in German on Oct. 10, 2024 as WO 2024/208520 A1 under PCT Article 21(2).

### FIELD

The present disclosure relates to an on-load tap-changer cover and an on-load tap-changer device with an on-load tap-changer cover.

### BACKGROUND

Pressure relief devices have been used in electrical equipment such as on-load tap-changers and transformers to be able to respond adequately to suddenly occurring pressure increases. However, these cannot always react quickly enough, especially in the event of high energy faults, which can lead to a destruction of the pressure relief device and also to the destruction of parts of the equipment.

### SUMMARY

In an embodiment, the present disclosure provides a cover for an onload tap changer. The cover includes a cover element with a first opening, and a throttle. The throttle is arranged in the first opening. The on-load tap-changer cover can be arranged such that the throttle is between a diverter switch compartment and a pressure relief device of an on-load tap changer such that a throughflow of an insulating medium is throttled by the throttle in the event of a rapid pressure increase in the diverter switch compartment.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a transformer having an on-load tap-changer;

FIGS. 2a and 2b show an on-load tap-changer cover and a sectional view of the on-load tap-changer cover;

FIG. 3 shows a throttle element;

FIG. 4 shows a sectional view of the on-load tap-changer cover with an inserted throttle element; and

FIG. 5 shows a further sectional view of the on-load tap-changer cover with an inserted throttle element.

### DETAILED DESCRIPTION

Aspects of the present disclosure provide an on-load tap-changer cover, which is simple in design and easy to assemble and at the same time provides a high degree of safety and reliability in the event of high energy faults.

Aspects of the present disclosure provide an on-load tap-changer device, which is simple in design and at the same time provides a high degree of safety and reliability in the event of high energy faults.

According to a first aspect, the present disclosure provides an on-load tap-changer cover, comprising:
a cover element with a first opening,
a throttle element; wherein
the throttle element is arranged in the first opening.

The on-load tap-changer cover with the installed throttle element creates a particularly simple and safe solution to be able to react to high energy faults in an on-load tap-changer. Due to the fact that the throttle element is arranged in the on-load tap-changer cover, an already installed on-load tap-changer cover on an on-load tap-changer can be particularly easily replaced or retrofitted with a new on-load tap-changer cover. The throttle element reduces the pressure generated in the on-load tap-changer and prevents a pressure relief device attached to the on-load tap-changer from being destroyed, thereby allowing insulating medium to enter an environment in an uncontrolled manner.

The on-load tap-changer cover can in a preferred implementation have a cover element, in which a first opening is made. The cover element is designed in such a way that it can be placed on the head of a diverter switch compartment and thereby closes it. The cover element is preferably designed as a circular disk. Bolts or screws are used to connect or screw the on-load tap-changer cover to the diverter switch compartment via the cover element. The cover element can also have further openings, e.g. for a drive shaft or oil intake or oil extraction connection.

Furthermore, the on-load tap-changer cover can have a flange element which is arranged directly above the first opening in the cover element. A pipe element of the flange element is connected to the cover element in a positively locking manner. The inner diameter of the pipe element is preferably greater than or equal to the diameter of the first opening. Due to the fact that the first opening has a smaller diameter than the inner diameter of the pipe element, a first throttling action of the insulating medium is already generated here during the throughflow of the on-load tap-changer cover.

The throttle element can be configured in any desired manner, for example as a static throttle element; this is preferably designed as a cylindrical cup, as a frustoconical cup or else as a dome-shaped cup. The throttle element is furthermore preferably configured in one piece.

The throttle element can have a ring wall, a bottom part and a second annular disk.

The ring wall can have at least one, preferably two, three or four apertures. The bottom part and the apertures in the ring wall of the throttle element cause throttling of the insulating medium when it rises from the diverter switch compartment through the first opening in the on-load tap-changer cover before it then passes further to the pressure relief device.

The on-load tap-changer cover can be designed in any desired manner, wherein
the throttle element has a ring groove;
the throttle element is fastened to the on-load tap-changer cover by means of a snap ring in the ring groove and the annular disk.

Furthermore, the throttle element can be screwed, adhesively bonded, soldered or welded in the on-load tap-changer cover. This can be any desired positively locking or non-positive connection between the two parts.

According to a second aspect, the present disclosure provides an on-load tap-changer device, comprising:
an on-load tap-changer with a diverter switch compartment filled which is with an insulating medium,
an on-load tap-changer cover;
a throttle element;
a pressure relief device;
   wherein
the throttle element is arranged in the on-load tap-changer cover;
the on-load tap-changer cover is arranged with the throttle element between the diverter switch compartment and the pressure relief device, and a throughflow of the insulating medium is throttled by the throttle element in the event of a rapid pressure increase in the diverter switch compartment.

The on-load tap-changer device provides a particularly high degree of safety during operation. The throttle element in the on-load tap-changer cover reduces the pressure which is generated in the on-load tap-changer and can be caused by high energy faults in the diverter switch compartment or in the transformer, with the result that the proper operation of the pressure relief device is ensured. In the event of a fault, the insulating medium inside the diverter switch compartment can escape in a controlled manner or can be conducted in a targeted manner into the environment via a drain pipe. The destruction of individual elements due to excessively high pressures and uncontrolled flying around of these parts are avoided. In the mounted state, the on-load tap-changer cover is attached on the diverter switch compartment of the on-load changer tap and closes it.

The throttle element is connected upstream of the pressure relief device and is located in the on-load tap-changer cover between the diverter switch compartment and the pressure relief device. The throttle element is designed here in such a way that the remaining and reduced pressure in the insulating medium downstream of the throttle element allows the pressure relief device to still respond reliably, but is reduced to such an extent that there is no damage to the pressure relief device.

The on-load tap-changer can be formed in any desired manner and can have, for example, at least one casing which is arranged on the on-load tap-changer cover and is connected to it. The casing and the on-load tap-changer cover are preferably bolted or riveted to the housing of the transformer.

The casing also serves as additional reinforcement and support for the on-load tap-changer cover in the event of a fault occurring in the diverter switch compartment.

The casing can be formed here in different ways, for example in one part or in multiple parts. The combination of casings and throttle element creates a particularly safe and reliable device which can withstand the high pressures in the event of a fault.

The casing and the on-load tap-changer cover are preferably screwed, riveted, adhesively bonded, soldered or welded to one another and to the housing of the transformer. This can be any desired positively locking or non-positive connection between the two parts.

Aspects of the present disclosures and associated advantages are described in detail below with reference to the accompanying drawings.

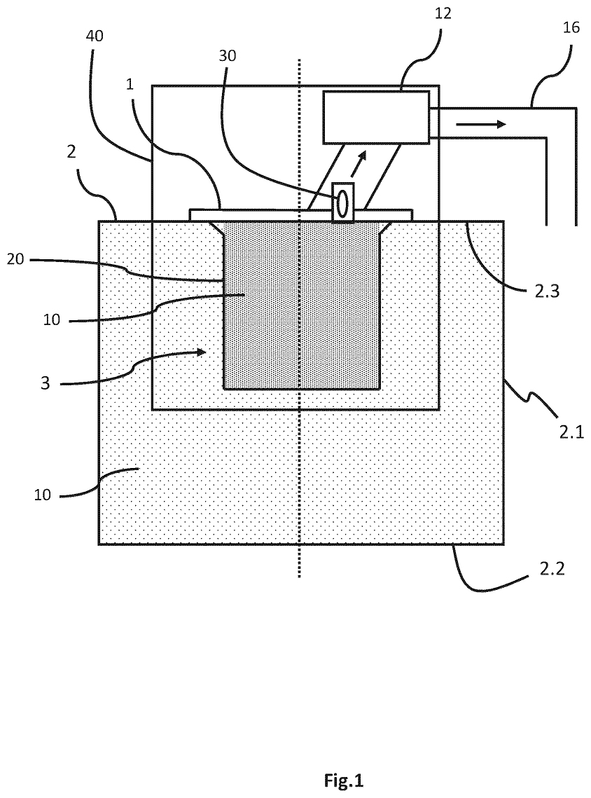

FIG. 1 shows a transformer 2 with an on-load tap-changer 3. The on-load tap-changer 3 is arranged here inside the transformer 2. The transformer 2 has a housing which consists of a bottom part 2.2, walls 2.1 and a cover 2.3. The on-load tap-changer 3 can have a diverter switch and a selector or can be designed as a selector switch. The on-load tap-changer 3 further comprises a diverter switch compartment 20, in which a diverter switch insert is arranged. Both the on-load tap-changer 3, and in particular its diverter switch compartment 20, and the transformer 2 are filled with an insulating medium 10. In the exemplary embodiment shown here, the insulating medium 10 in the transformer 2 has no contact with the insulating medium 10 in the on-load tap-changer 3; there is no exchange between them. However, alternative embodiments can enable or have an exchange.

The insulating medium 10 can be a natural or artificial insulating medium such as a mineral insulating oil or ester. The on-load tap-changer 3 is fastened to the cover 2.3 of the transformer 2. Here, the diverter switch compartment 20 is closed by way of an on-load tap-changer cover 1. The on-load tap-changer cover 1 is connected here to the cover 2.3 of the transformer 1. A pressure relief device 12 is attached externally to the on-load tap-changer cover 1 via a flange element (also referred to herein simply as a flange) 1.2. In this embodiment, the pressure relief device 12 is connected to a drain pipe 16.

The pressure relief device 12 is designed and configured to provide pressure relief in the diverter switch compartment 20 of the on-load tap-changer 3 in the event of pressure increases due to faults or malfunctions. Here, the pressure arising in the interior of the on-load tap-changer 3 or, in particular, the pressure arising in the interior of the diverter switch compartment 20 is discharged via the on-load tap-changer cover 1 and the pressure relief device 12 arranged thereon to the environment. Pressurized insulating medium 10 and air can be discharged without damaging the transformer 2, the on-load tap-changer 3 or other parts. In detail, in the event of a fault, an electric arc which leads to a large current flow between electrodes is created in the on-load tap-changer 3. The gas generated in the arc under high pressure is conveyed to the outside by a pressure wave due to the pressure difference to the environment. Depending on the fault energy and the location of the fault, a pressure relief device 12 can ensure pressure relief before an excessively high pressure increase occurs, and critical components fail, which in extreme cases can lead to the destruction of on-load tap-changer 3 or the transformer 1. Existing pressure relief devices are not designed to relieve the pressure of such high energy malfunctions.

During normal operation of on-load tap-changer 3, the pressure relief device 12 is closed. In this first state, the pressure in the diverter switch compartment 20 lies within a predetermined limit value. The volume of the insulating medium 10 which is located in the diverter switch compartment 20 of the on-load tap-changer 3 does not exceed its predetermined magnitude in this first state.

A throttle element (also referred to herein as simply a throttle) 30 which is mounted in the on-load tap-changer cover 1 brings it about that, in the event of faults occurring with a very high energy content and a steep pressure increase, the resulting pressure is reduced, whereby a possible destruction of the pressure relief device 12 by a pressure wave is avoided.

The throttle element 30 is connected upstream of the pressure relief device 12 and is located in the on-load tap-changer cover 1 between the diverter switch compartment 20 and the pressure relief device 12. The throttle element 30 is formed here in such a way that the remaining and reduced pressure in the insulating medium 10 downstream of the throttle element 30 allows the pressure relief device 12 to still reliably respond, but is reduced to such an extent that no damage to the pressure relief device 12 occurs.

Furthermore, an on-load tap-changer device 40 is shown, which comprises the on-load tap-changer 3, the on-load tap-changer cover 1, the throttle element 30 and the pressure relief device 12.

A transformer cover is also understood as an on-load tap-changer cover 1 in the sense of the present disclosure. Here, a corresponding transformer cover also has an opening with a throttle element introduced into it. The throttle element is even then connected upstream of a pressure relief device. The throttle element then throttles a pressure rise occurring in the insulating medium of a transformer and thus prevents the destruction of the pressure relief device. The transformer cover can have an appropriate flange with an annular disk for fastening the pressure relief device above the throttle element.

The flow resistance generated by the throttle element is designed such that the pressure relief device 12 can operate or function non-destructively in the event of a high energy fault.

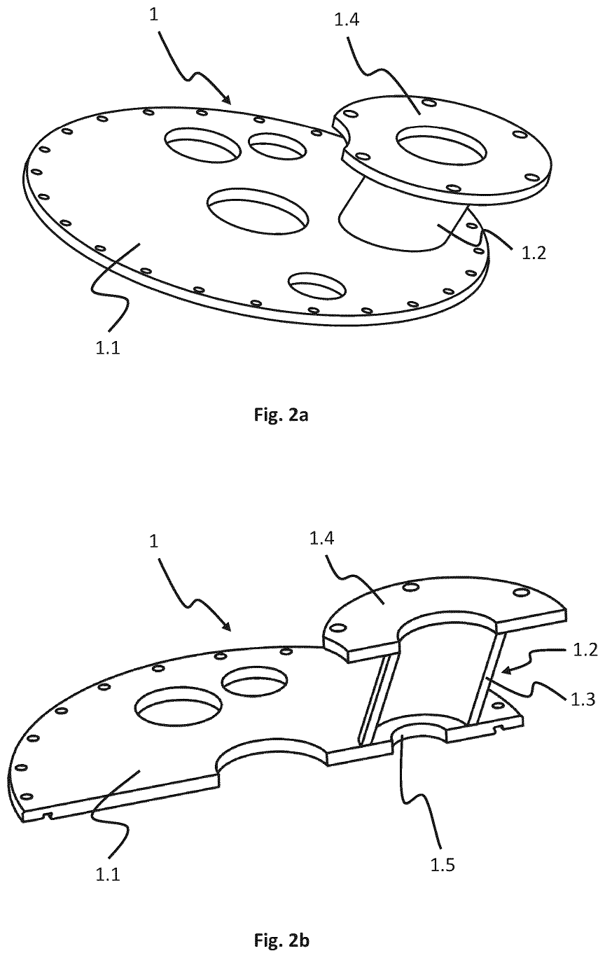

FIGS. 2a and 2b show an on-load tap-changer cover 1. This comprises a cover element 1.1 substantially formed as a round disk. In the cover element 1.1, a first opening 1.5 is arranged which extends from a first side of the cover element 1.1 to a second opposite side of the cover element 1.1. The first opening 1.5 is preferably of circular design and has a defined cross section. The first opening 1.5 can be arranged at any desired point in the cover element 1.1, but preferably not in the center. Directly above the first opening 1.5, a flange element 1.2 is arranged on the cover element 1.1. The flange element 1.2 has a pipe element (also referred to herein simply as a pipe) 1.3 and a first annular disk 1.4. The first end of the pipe element 1.3 is connected to the annular disk 1.4. The second end of the pipe element 1.3 is connected to the cover element 1.1 in a positively locking manner. The cover element 1.1, the flange element 1.2 with the pipe element 1.3, and the first annular disk 1.4 are designed as a cast part. The inner cross section or diameter of the pipe element 1.3 is greater here than the cross section of the first opening 1.5.

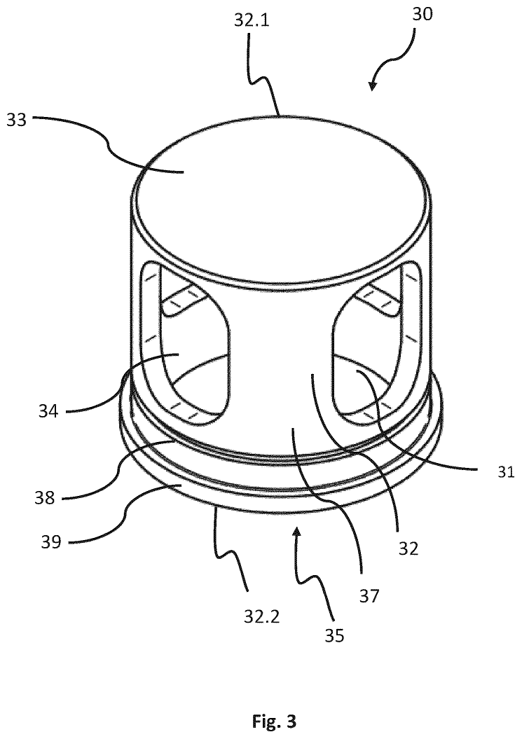

FIG. 3 shows a detailed view of the throttle element 30. The throttle element 30 is attached in the opening 1.5 of the on-load tap-changer cover 1 in the mounted state. The throttle element 30 is designed in this embodiment as a cylindrical cup. Furthermore, the throttle element 30 can also be designed as a frustoconical cup or as a dome-shaped cup. The throttle element 30 has a circumferential ring wall 32 which has a bottom part 33 at its first end 32.1. At a second end 32.2 which is arranged opposite the first end 32.1, the throttle element 30 is open and has a throttle opening 35. At the second end 32.2 of the ring wall 32, a ring groove 38 and a second annular disk 39 are inserted or formed on an outer surface 37 of the ring wall 32. The outer diameter at the second end 32.2 of the ring wall 32 corresponds substantially to the diameter of the first opening 1.5 of the on-load tap-changer cover 1. In the mounted state, the throttle element 30 is inserted in the first opening 1.5 of the on-load tap-changer cover 1 or is connected to the latter. The fastening of the throttle element 30 in the first opening 1.5 of the on-load tap-changer cover 1 is carried out in this embodiment by means of a snap ring via the ring groove 38 and the second annular disk 39. In the mounted state, the throttle opening 35 forms the first opening 1.5 of the on-load tap-changer cover 1. The ring wall 32 also has at least one opening or one aperture 34. In the embodiment shown here, the ring wall 32 has four apertures 34 which are distributed uniformly in the ring wall 32. In this embodiment, the throttle element 30 is designed as a static throttle with a constant cross-sectional constriction.

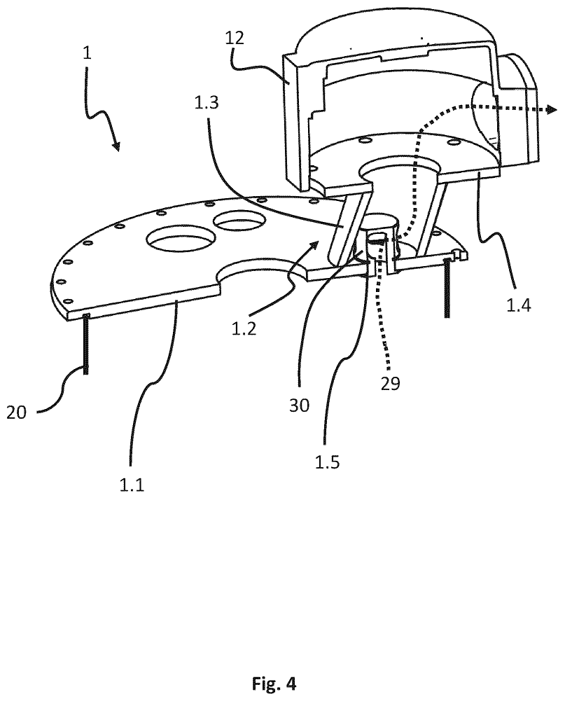

FIG. 4 shows a sectional view of the on-load tap-changer cover 1 with an inserted throttle element 30. The throttle element 30 is inserted here in the first opening 1.5 of the on-load tap-changer cover 1 or connected to the latter. In the mounted state, the throttle element 30 protrudes into the pipe element 1.3 of the flange element 1.2, i.e. toward the pressure relief device 12. The dotted arrow 29 shows a possible flow of the insulating medium 10 from the on-load tap-changer 3 and, in particular, the diverter switch compartment 20 outward. In this case, a drain pipe 16 can also be connected to the pressure relief device 12, which drain pipe controls or discharges the flow of the insulating medium 10 to the outside. When leaving the diverter switch compartment 20, the insulating medium 10 flows through the first opening 1.5, in particular the throttle opening 35 into the interior of the throttle element 30, whereby the first throttling of the flow takes place. Here, the insulating medium 10 is throttled or braked, inter alia, by the bottom part 33. Furthermore, the insulating medium 10 is further throttled when leaving the throttle element 30 through the apertures 34 in the ring wall 32.

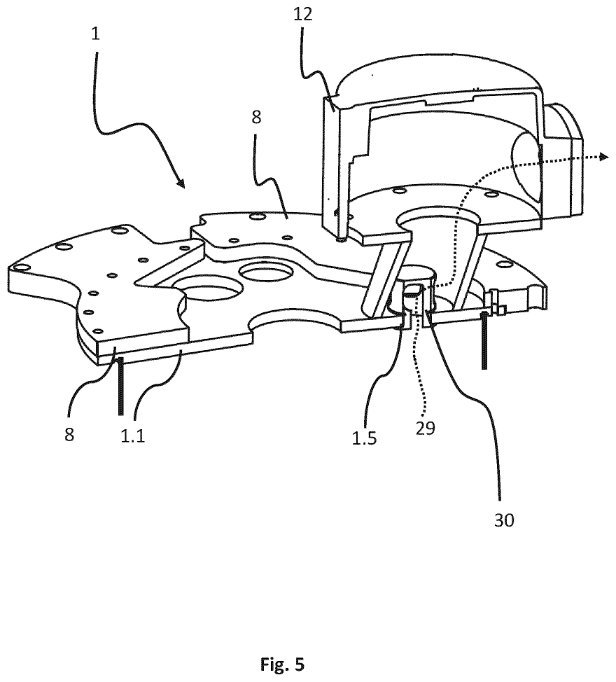

FIG. 5 shows a sectional view of the on-load tap-changer cover 1 with an inserted throttle element 30. The throttle element 30 is inserted here in the first opening 1.5 of the on-load tap-changer cover 1 or connected to the latter. The arrow 29 shows a possible flow of the insulating medium 10 from the on-load tap-changer 3 to the outside. Furthermore, two casings 8 are arranged on the on-load tap-changer cover 1, which are designed to reinforce the on-load tap-changer cover 1 and make it more stable. Here, the casings 8 can cover the complete on-load tap-changer cover 1 or only parts thereof and thus strengthen it/them, or can also be formed as a one-piece casing 8 or, in other embodiments, consist of more than two parts. The casing 8 can, for example, be designed as sickle or arc-shaped plates made of metal. The combination of casings 8 and an on-load tap-changer cover 1 with a throttle element 30 creates a particularly safe and reliable on-load tap-changer device 40. This configuration ensures that, in the event of high energy faults in the on-load tap-changer 3 or transformer 1, the pressure relief device 12 functions properly. It is avoided that individual parts break away and are thrown into the environment and thus insulating medium 10 passes in an uncontrolled manner into the environment. The casings 8 are screwed onto the on-load tap-changer 3 and/or the transformer housing with the on-load tap-changer cover 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF DESIGNATIONS

1 On-load tap-changer cover
1.1 Cover element
1.2 Flange element
1.3 Pipe element
1.4 First annular disk
1.5 First opening
2 Transformer
2.1 Wall
2.2 Bottom part
2.3 Cover
3 On-load tap-changer
8 Casing
10 Insulating medium
12 Pressure relief device
16 Drain pipe
20 Diverter switch compartment
30 Throttle element
32 Ring wall
32.1 First end
32.2 Second end
33 Bottom part
34 Aperture
35 Throttle opening
37 Outer surface
38 Ring groove
39 Second annular disk
40 On-load tap-changer device

1. An on-load tap-changer cover, comprising:
a cover element with a first opening; and
a throttle,
wherein the throttle is arranged in the first opening.

2. The on-load tap-changer cover as claimed in claim 1, further comprising:
flange with a pipe which is formed directly above the first opening;
wherein an inner diameter of the pipe is greater than a diameter of the first opening.

3. The on-load tap-changer cover as claimed in claim 1, whereinthe throttle is formed as a static throttle.

4. The on-load tap-changer cover as claimed in claim wherein the throttle is formed as a cylindrical cup, as a frustoconical cup, or as a dome-shaped cup.

5. The on-load tap-changer cover as claimed in claim wherein:
throttle comprises an annular wall, a bottom part, and an annular disk; and
the annular wall has at least one aperture.

6. The on-load tap-changer cover as claimed in claim 1, wherein:
the throttle has a ring groove and an annular disk, and
throttle is fastened to the cover element using a snap ring in the ring groove and the annular disk

7. An on-load tap-changer system comprising:
an on-load tap-changer with a diverter switch compartment which is filled with an insulating medium;
an on-load tap-changer cover;
a throttle-element; and
a pressure relief device,
wherein:
the throttle is arranged in the on-load tap-changer cover, and
the on-load tap-changer cover is arranged with the throttle between the diverter switch compartment and the pressure relief device and a throughflow of the insulating medium is configured to be throttled by the throttle in an event of a pressure increase in the diverter switch compartment

8. The on-load tap-changer system as claimed in claim 7, further comprising at least one casing which is arranged on and connected to the on-load tap-changer cover.

9. The on-load tap-changer system as claimed in claim 8, wherein the casing and the on-load tap-changer cover are bolted or riveted to the-a housing of a transformer.
